(19) United States
(12) Patent Application Publication
(10) Pub. No.: US 2015/0298081 A1
(43) Pub. Date: Oct. 22, 2015

(54) PORTABLE INGREDIENTS SYSTEM

(71) Applicant: DANIEL JEFFREY MCMATH, Gaithersburg, MD (US)

(72) Inventor: DANIEL JEFFREY MCMATH, Gaithersburg, MD (US)

(21) Appl. No.: 14/689,002

(22) Filed: Apr. 16, 2015

Related U.S. Application Data
(60) Provisional application No. 61/980,493, filed on Apr. 16, 2014.

(51) Int. Cl. B01F 15/00; C12C 13/02; B01F 13/10; A21C 1/14; B01F 15/02; C12C 13/10; A47J 47/01

(52) U.S. Cl. CPC B01F 15/00311; C12C 13/10; C12C 13/02; A47J 47/01; A21C 1/1425; B01F 15/0216; B01F 13/1066; B01F 2215/0011; B01F 2215/0014; B01F 2215/0068

(57) ABSTRACT

A portable ingredients system is provided. An example assembly attaches to the side of a kettle, mixing bowl, pot, vat, or vessel and adds ingredients at programmed intervals. In an implementation, only that part of the assembly that adds the ingredients is located over the kettle or vessel. In an implementation, a microprocessor controls a stepper motor to precisely drive a rotary dispenser containing the ingredients to be added separately at time intervals. The example assembly may be preloaded with ingredients for a recipe, such as for mixing a batter, making a soup, or brewing a beer, for example. The assembly may be preprogrammed with one or more electronic recipes for instructing the microprocessor to create the intended food or drink item using ingredients, such as preloaded ingredients.

### RELATED APPLICATIONS

This patent application claims the benefit of priority to U.S. Provisional Patent No. 61/980,493 to McMath, filed Apr. 16, 2014 and incorporated herein by reference in its entirety.

### BACKGROUND

A common step in cooking, baking, and brewing involves heating water to a specified temperature then adding ingredients over a period of time, typically one to two hours. An operator manually controls the temperature then waits patiently for the right time to add the specified ingredients and adjuncts according to the intended recipe. Adding the intended ingredients at the right time is essential for achieving a repeatable process. But this requires continuous attention from the operator to manage a timer or a series of timers to ensure that ingredients are added at the right time, and requires freedom from distraction during long periods when ingredients are not being added. Variance in timing when following a recipe can significantly change the intended outcome.

Timing the ingredients can be even more critical in a brewing process, in which times and temperatures are essential to producing quality beverages and reproducibility.

In a beer brewing process, a wort is a sweet infusion of ground malt or other grain before fermentation. Wort is generally produced by heating water to a precise temperature, steeping crushed grains in the water for a period of time, and then filtering the grains out after the sugars have been extracted. A brewer may turn wort into beer by adding yeast and waiting until some of the sugars have been converted to alcohol.

An adjunct is an ingredient added to wort or beer that is neither a grain nor a hop. The “brew kettle” is a pot, typically of stainless steel or aluminum, used to heat the wort in the production of beer. Heating methods may include a stove-top, an external burner, or an electric heat source.

For a description of an example brewing process, U.S. Patent Publication No. 2015/0000530 to Hoang describes a device designed to automate the entire brewing process. The system uses a pump to draw fluid from a reservoir through one of several chambers containing ingredients.

Likewise, U.S. Pat. No. 6,032,571 to Brous describes a device for automating an entire process of brewing, start to finish, which uses a complex assembly to add ingredients. The Brous system uses funnel-shaped ingredient-addition cups to fit a small opening in the lid of the brewing vessel. Such funnels are prone to ingredient blockage causing unreliable or absent ingredient addition. This requires the brewer to manually inspect the ingredient containers after each “add” to ensure success, thus decreasing the automaticity of the system.

### SUMMARY

An example assembly attaches to the side of a vessel and adds ingredients at programmed intervals. In an implementation, only that part of the assembly that adds the ingredients is located over the kettle or vessel. In an implementation, a microprocessor controls a stepper motor to precisely drive a rotary dispenser containing the ingredients to be added separately at time intervals. The example assembly may be preloaded with ingredients for a recipe, such as for mixing a batter, making a soup, or brewing a beer, for example. The assembly may be preprogrammed with one or more electronic recipes for instructing the microprocessor to create the intended food or drink item using ingredients, such as preloaded ingredients.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the same numbers are used for the same component or feature, when possible.

For this description, the devices and systems illustrated in the figures are shown as having a multiplicity of components. Various implementations of devices and systems, as described herein, may include fewer components and remain within the scope of the disclosure. Alternately, other implementations of devices and systems may include additional components, or various combinations of the described components, and remain within the scope of the disclosure.

FIG. 1 is a diagram of an example portable ingredients system mounted on a vessel.

FIG. 2 is a diagram of an example portable ingredients system.

FIG. 3 is a diagram of the example portable ingredients system showing gear arrangement.

FIG. 4 is a diagram of the example portable ingredients system showing planetary reduction gear arrangement.

FIG. 5 is a diagram of the example portable ingredients system with bearing exposed.

FIG. 6 is a diagram of the example portable ingredients system showing example motor mounting holes.

FIG. 7 is a cross section of the example portable ingredients system viewed from line A in FIG. 3.

FIG. 8 is a block diagram of an example controller of the example portable ingredients system.

FIG. 9 is a screenshot of an example web page implementation of a user interface.

### DETAILED DESCRIPTION

### Overview

This disclosure describes portable ingredients systems. Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

In an implementation of the portable ingredients system, an example assembly attaches to the side of a kettle, mixing bowl, pot, vat, or vessel and adds ingredients at programmed intervals. In an implementation, only that part of the assembly that adds the ingredients is located over the kettle or vessel. In an implementation, a microprocessor controls a stepper motor to precisely drive a rotary dispenser containing the ingredients to be added separately at time intervals. The example assembly may be preloaded with ingredients for a recipe, such as for mixing a batter, making a soup, or brewing a beer, for example. The assembly may be preprogrammed with one or more electronic recipes for instructing the microprocessor to create the intended food or drink item using ingredients, such as preloaded ingredients.

The example portable ingredients system 100 is different from conventional solutions in that it does not seek to replace the chef, baker, or brewer's entire inventory of cooking, baking, or brewing tools by automating an entire process. Rather, the example portable ingredients system is a tool that augments the existing cooking, baking, or brewing system. In an implementation, a mechanical simplicity of the example portable ingredients system makes it more reliable and easier to manufacture than conventional designs, while still providing advantages, such as heavy-duty torque to move even heavy loads of ingredients.

### Example Systems

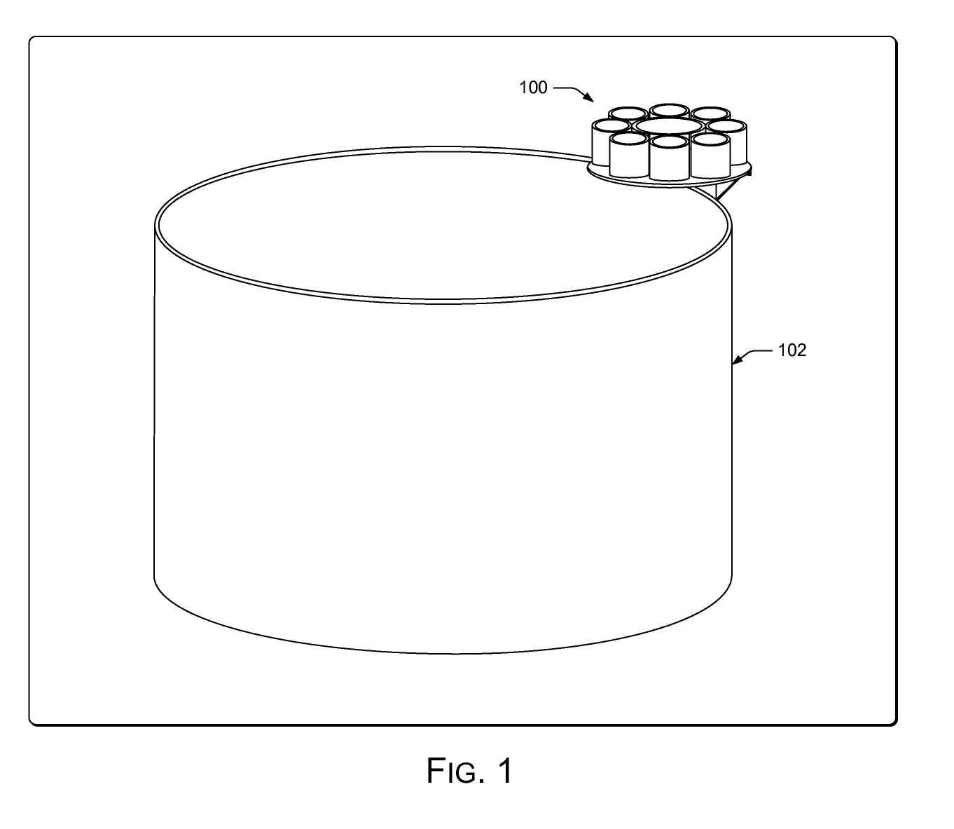

FIG. 1 shows an example portable ingredients system 100 residing on the side of a pot or vessel 102. In an implementation, the example portable ingredients system 100 is self-contained with one or more mounting members that allow the portable ingredients system 100 to be retrofitted to a preexisting vessel 102, or carried from vessel to vessel 102. The example portable ingredients system 100 mounts in a manner that can minimize the amount of open pot area eclipsed by the presence of the example portable ingredients system 100. In brewing beer, for example, the low profile of the portable ingredients system 100 over the brewing vessel 102 can help solve problems unique to brewing. For example, malted grains contain byproducts which, when heated, produce dimethyl sulfide (DMS). If DMS remains in the wort it produces off-flavors and undesirable odors. DMS is highly volatile, however, and is readily removed from the wort by vigorously boiling the open pot. Since, only a small portion of the example portable ingredients system 100 is situated over the vessel 102, this minimizes the chances of contamination and allows maximum DMS boil-off to reduce its presence. The example portable ingredients system 100 also uses ingredient delivery tubes that have vertical container walls, which eliminates ingredient clogs. This also increases reliability.

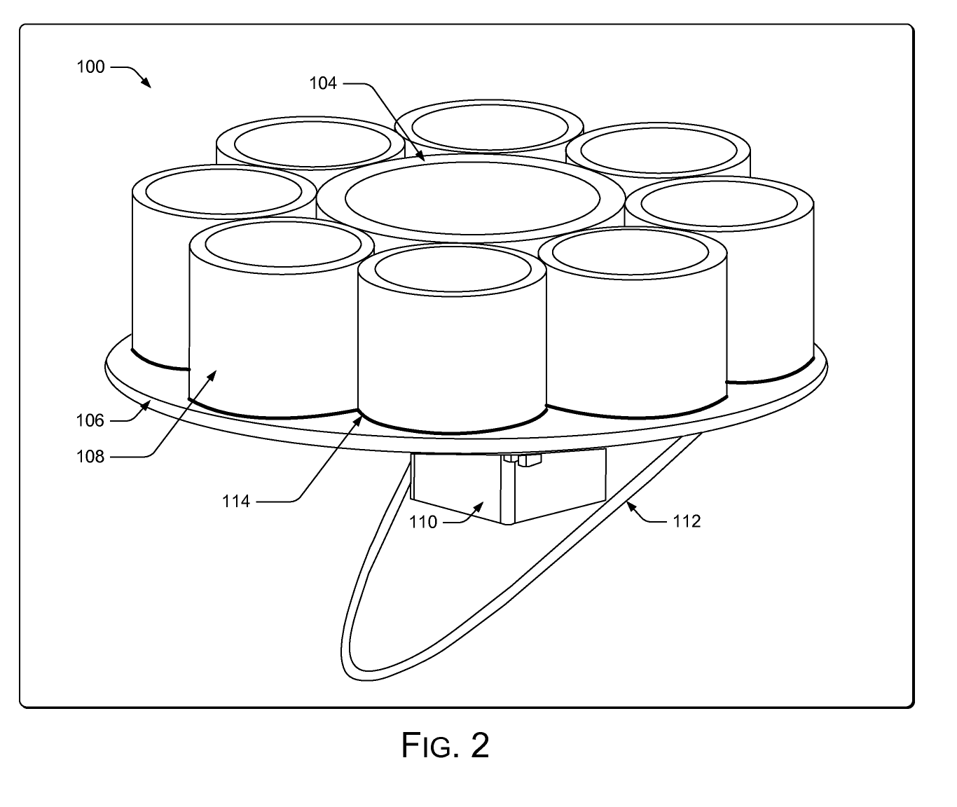

FIG. 2 shows the example portable ingredients system 100 of FIG. 1, in greater detail. A turntable or rotating assembly 104 is rotatably attached to a base plate 106. Containers 108, such as vertical tubes, are attached to the rotating assembly 104 for sequentially passing ingredients into the vessel 102 through a hole in the base plate 106. A motor 110 is attached to the base plate 106 for rotating the turntable or rotating assembly 104. A mounting assembly 112 is attached to the base plate 106 for removably attaching the base plate 106 to the vessel 102 such that only a portion of the base plate 106 that has the hole is over the open top of the vessel 102. In an implementation, a movable seal 114 intervenes between each container 108 attached to the rotating assembly 104 and the base plate 106. Each movable seal 114 secures an ingredient in the respective container 108 during rotation of the container 108 around a stationary face of the base plate 106.

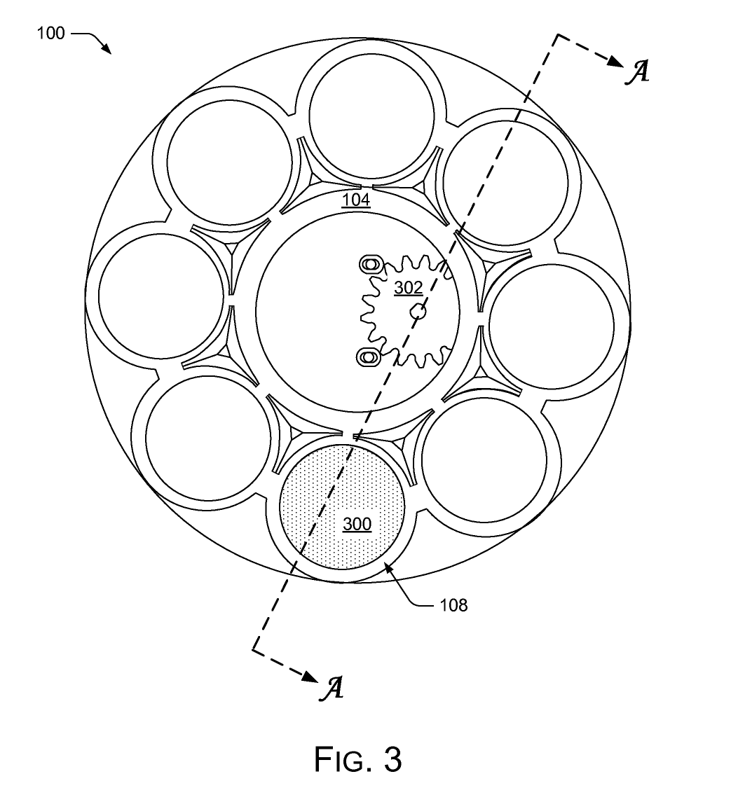

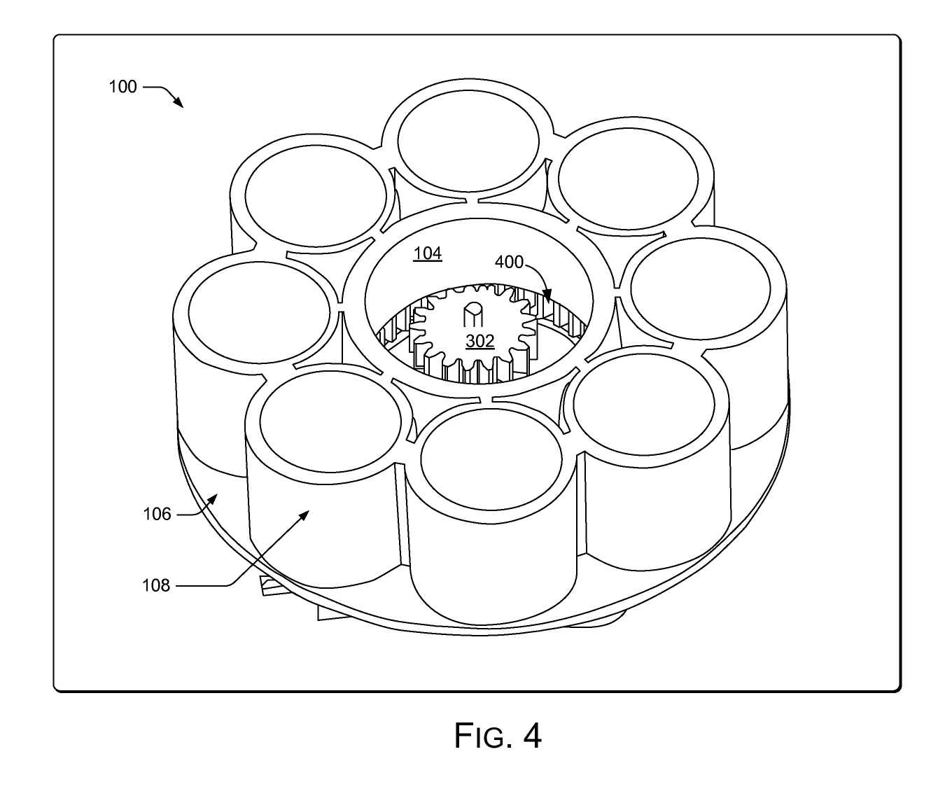

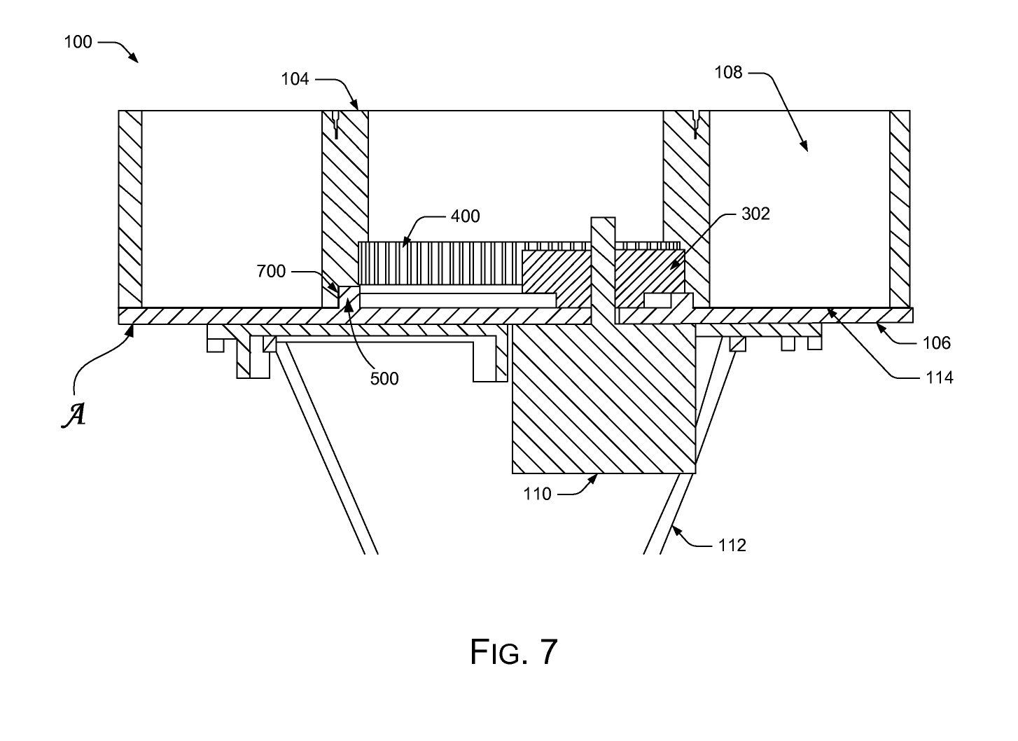

As shown in FIG. 3, when a container 108 aligns with a hole 300 in the base plate 106, the ingredients are dispensed, e.g., via gravity, into the vessel 102. In an implementation, the motor 110 drives a small gear 302 of a reduction gear set. The reduction gear scheme can consist of the single smaller pinion gear 302 attached to the motor 110, driving a larger internal planetary gear (e.g., 400 in FIG. 4) integral to the rotating assembly 104. A helical or cross-cut gear system may also be used. The relatively simple drive mechanism, having a minimum of parts, provides reliable rotation and low maintenance and cleaning. Conventional load motors, on the other hand, rely upon external mechanical assemblies to trigger a desired motion and provide power to the motor, or to apply friction to stop rotation of the assembly regardless of whether the motor is still running. But moving parts can break or jam, resulting in uncontrolled motor movement. Systems that rely on friction or on inserting a block in the path of motion for braking may fail, again resulting in uncontrolled motor movement. in FIG. 3, line A indicates a cross-sectional view to be shown in FIG. 7.

In an implementation, the example portable ingredients system 100 incorporates a stepper motor 110. The stepper motor 110 uses an external microcontroller to provide a specific signal that causes the motor to rotate each single step, which is a fixed angular rotation based on mechanical properties of the motor. The stepper motor 110 allows for precise, repeatable, and consistent rotation of ingredients for addition, using only a small motor.

As shown in FIG. 4, gear teeth 400 providing a larger gear of the reduction gear set, that also includes smaller gear 302, can be built-in or otherwise integrated into the turntable or rotating assembly 104. In an implementation, the motor 110 is a stepper motor to rotate the turntable or rotating assembly 104 through a preprogrammed angle or arc length, to increase the reliability and precision of the example portable ingredients system 100.

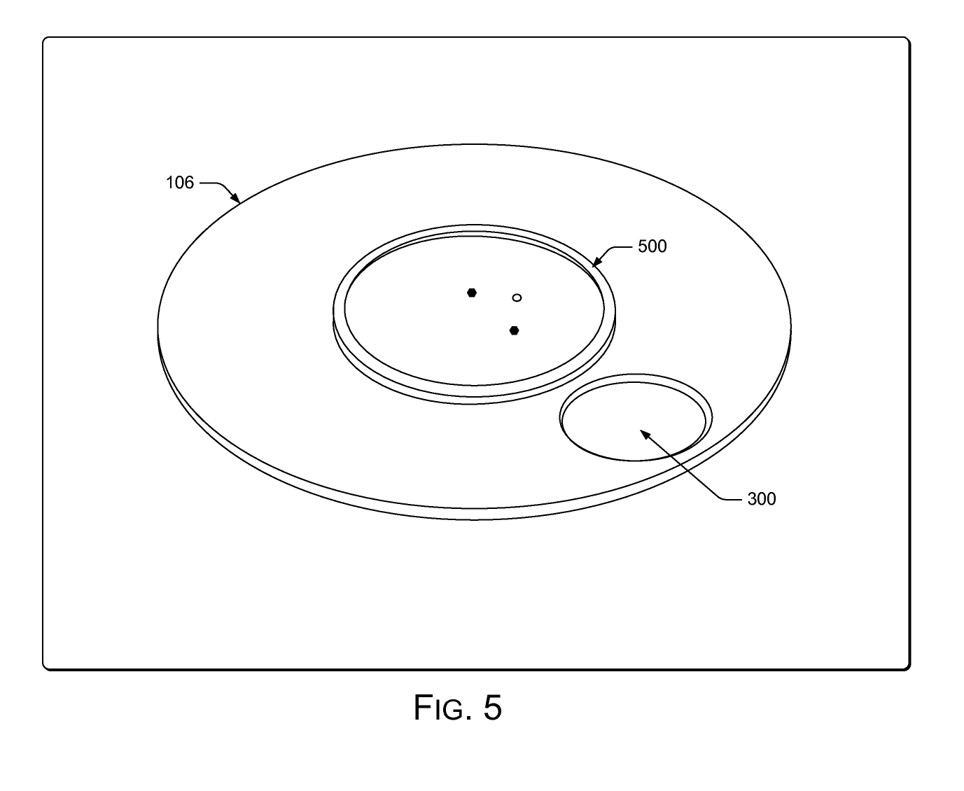

FIG. 5 shows an example base plate 106 of the example portable ingredients system 100. Each ingredient container 108 is rotated over the hole 300 in the base plate 106 in sequence, driven by a stepper motor 110. In an implementation, the rotating assembly 104 is held in axial alignment over the base plate 106, not by a central axle or shaft, but by a larger bearing ring 500 on the base plate 106. The bearing ring 500 disperses friction of the rotating assembly 104 and ensures consistent alignment of the rotating assembly 104 with respect to both the meshing gear teeth 400 and the base plate 106.

Conventionally rotating hardware, by comparison, uses complex bearing systems that increase cost and introduces complexity into the mechanism. Because conventional solutions are built around standard industrial machine designs, they generally have large center shafts with only radial shaft bearings on the shaft to reduce friction and ensure alignment of rotating assemblies. The example portable ingredients system 100, on the other hand, reduces friction by dramatically increasing the surface area of the bearing surface 500. Instead of a using a small shaft, the rotating assembly 104 of the example portable ingredients system 100 rides on a bearing ring of much greater radius. This reduces the overall component count and overall complexity of the hardware, while aligning rotating parts and carrying sufficiently low friction that a small motor can drive the entire assembly.

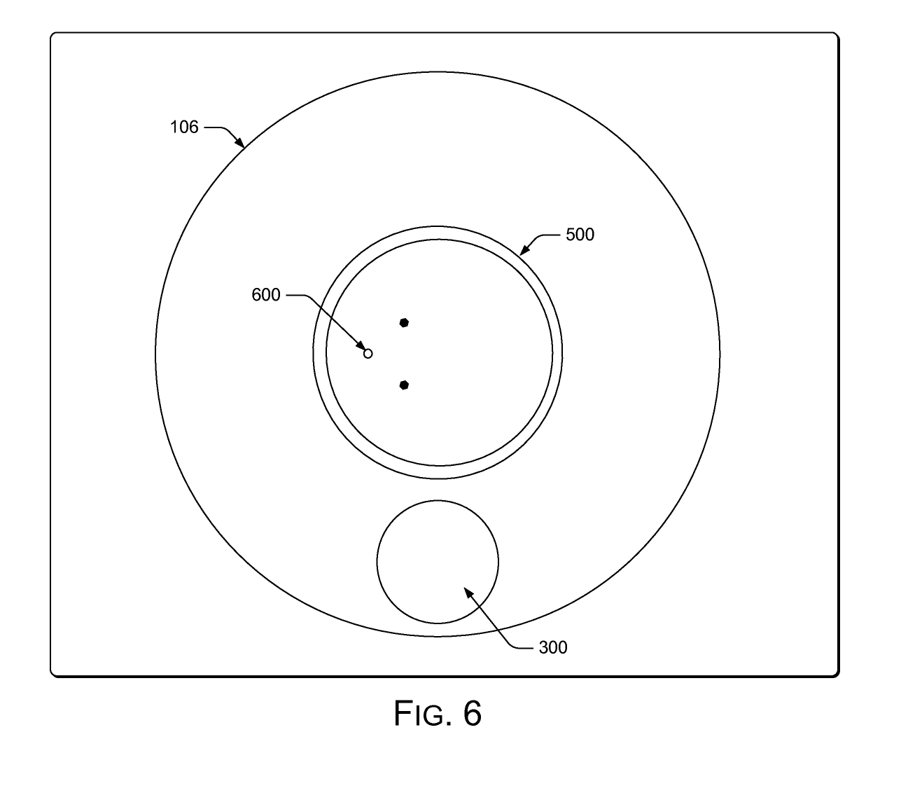

As shown in FIG. 6, the motor 110 may be attached to the base plate 106 at a mounting location 600. The motor 110, such as a stepper motor 110, rotates the pinion gear 302, which has teeth that mesh with a set of gear teeth 400 integral to an inside surface of the rotating assembly 104, thus providing a simple means of including a reduction gear mechanism as part of the structure of the rotating assembly 104. As each tube or container 108 is rotated over the hole 300, the contents of the tube or container 108 are discharged by gravity into the vessel 102.

FIG. 7 shows a cross-section of the example portable ingredients system 100, viewed from line A in FIG. 3. In an implementation, an outer diameter of the bearing 500 maintains the rotating assembly 104 in axial alignment with the base plate 106. The bearing 500 may be a feature of the base plate 106, or a washer, with a low friction layer or coating, such as polytetrafluoroethylene, i.e., PTFE or TEFLON (DuPont, Wilmington, Delaware), upon which a surface of the rotating assembly 104 rides. A radial surface of the bearing 500 may also make low-friction contact 700 with an inside diameter of the rotating assembly 104. The bearing 500 may also be a ball-bearing, magnetic, or sliding surface style of bearing, depending on implementation.

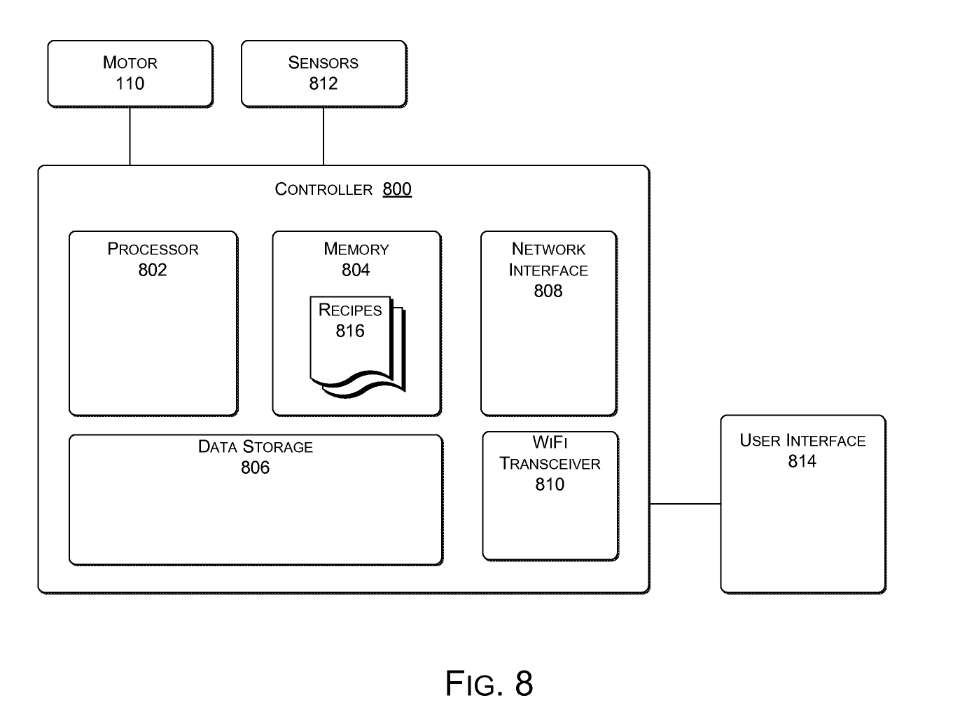

FIG. 8 shows an example controller 800 of the example portable ingredients system 100. In an example implementation, the example controller 800 is aboard the example portable ingredients system 100. In another implementation, the example controller 800 is communicatively coupled with the example portable ingredients system 100, but remote.

The example controller 800 includes a processor 802 (or microcontroller), a memory 804, and data storage 806. In an implementation, the example controller includes a network interface 808, and may include a wireless (wifi) transceiver 810. The example controller 800 can control the motor 110, such as a stepper motor 110. The example controller 800 may also connect to one or more sensors 812 (e.g., temperature, stirring speed, external timer, etc.), and display sensor parameters on a user interface 814. The processor 802 may also time intervals from a starting time or between ingredient additions, and control the motor 110 to add ingredients based on input from the one or more sensors 812.

The user interface 814 may be used by an operator to program one or more recipes 816. The user interface may be aboard the example portable ingredients system 100, or may be remote, such as accessible on a browsed Internet web page, or available via an application on a mobile device, such as a cell phone.

Prepared recipes 816 may also be installed or downloaded into the example controller 800 via a port of the network interface 808 or via a wireless transmission received by the wifi transceiver 810. Once aboard, a recipe 816 may be stored in the data storage 806 (e.g., flash memory, and so forth) or as instructions in volatile memory 804.

In a beer brewing example, an example recipe 816 may include instructions for the controller 800, paraphrased, for example, as: one ounce of Zeus hops in a first ingredients container 108, 0.5 ounces of dried orange peel in the second ingredients container 108, 0.5 ounces of Cascade hops in the third ingredients container 108, one ounce of crushed coriander in the fourth ingredients container 108, a teaspoon of Irish Moss in the fifth ingredients container 108, and one ounce of Fuggle hops in the fifth ingredients container 108.

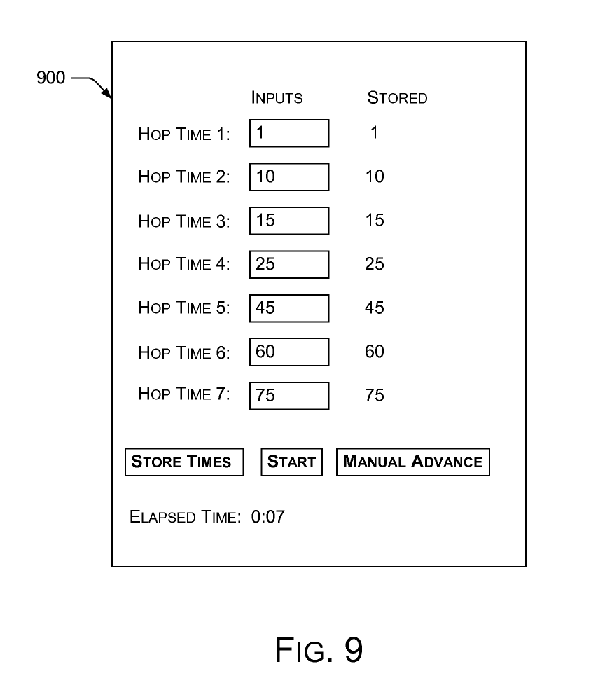

As shown in FIG. 9, in a web page interface example of the user interface 814, the user, operator, or brewer can browse to a dedicated web page 900 via the network interface 808 and/or the wifi transceiver 810 using a capable device (e.g. phone, tablet, computer) and enter appropriate times or intervals for each of the ingredients to be added to the boil by the example portable ingredients system 100.

When the wort reaches a boil, the brewer can press the “Start” button on the user interface 814 or web page 900 to activate the timer. Or, the controller 800 may start the process of adding ingredients. For example, the controller 800 may monitor temperature, and start a timer when a boil has been reached. The processor 802 monitors time elapsed. In an implementation, at each time step, the processor 802 (or microcontroller) compares the elapsed time to the next entered time; if the elapsed time is greater than or equal to the next time, the controller 800 activates the stepper motor 110 to rotate the rotating assembly 104 to the next container 108 for ingredient addition. The controller 800 can alert the user when the brew, or other recipe 816, is finished, so that brewer or other operator can remove, for example, the wort from heat and proceed to cool the batch in preparation for adding yeast. Optionally, the brewer may also pause the timer using a “Pause” button, or force the rotating assembly 104 to advance one container 108 by using the “Manual Advance” button.

In an implementation, a recipe 816 entered by the user or downloaded via the network interface 808 and/or wifi transceiver 810 runs everything concerning a food or drink production, including sensing and controlling external parameters such as heat source, temperature, and stirring speed, for example, in addition to sequentially adding the ingredients at correct time intervals.

In an implementation, the example portable ingredients system 100 comes prepackaged with a plurality of ingredients, and in one scenario each ingredient is already prepackaged in a respective container 108 attached to the rotating assembly 104 or turntable. A recipe 816 stored in the tangible data storage 806 is associated with the prepackaged ingredients and directs the addition of the ingredients to the vessel 102 at programmed intervals to execute the recipe 816. The recipe 816 may be for a soup, a pastry, a beer, etc., or other food or drink item.

The example portable ingredients system 100 may thus be a standalone kit, wrapped for marketing, that includes the hardware, recipes 816 as software or on paper, and ingredients for making the food or drink item.

### Conclusion

Although only a few example embodiments have been described in detail above, those skilled in the art will readily appreciate that many modifications are possible in the example embodiments without materially departing from the subject matter. Accordingly, all such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 U.S.C. §112, paragraph 6 for any limitations of any of the claims herein, except for those in which the claim expressly uses the words ‘means for’ together with an associated function.

1. A portable ingredients system, comprising:
a base plate;
a turntable rotatably attached to the base plate;
gear teeth integrated into the turntable;
a motor attached to the base plate for rotating the turntable by engaging the gear teeth in a reduction-gear relationship;
containers attached to the turntable for sequentially passing ingredients into the vessel through a hole in the base plate; and
a mounting assembly for removably attaching the base plate to a vessel such that only a portion of the base plate that has the hole is over an open top of the vessel.

2. The portable ingredients system of claim 1, further comprising a movable seal between each container attached to the turntable and the base plate, wherein each movable seal secures an ingredient in the respective container during rotation of the container around a stationary face of the base plate until the container aligns with the hole in the base plate.

3. The portable ingredients system of claim 1, wherein the motor comprises a stepper motor to rotate the turntable through a preprogrammed angle or arc length.

4. The portable ingredients system of claim 1, further comprising a bearing ring on the base plate with an outer radius approximately equal to an inner radius tangential to each of the vertically oriented tubes, such that the bearing ring circularly aligns the rotating assembly centered on the base plate as it rotates.

5. The portable ingredients system of claim 1, further comprising a processor to control the motor for moving the turntable, wherein when a container is moved over the hole in the base plate, an ingredient in the container is released into the vessel.

6. The portable ingredients system of claim 5, further comprising a user interface for programming the processor or controller.

7. The portable ingredients system of claim 6, wherein the processor or controller signals the user interface to display a status of the vessel or a status of a process of adding the ingredients to the vessel.

8. The portable ingredients system of claim 5, further comprising:
a plurality of ingredients, each ingredient prepackaged in a respective container attached to the turntable;
a tangible data storage memory; and
a recipe storable in the tangible data storage memory, the recipe associated with the prepackaged ingredients for adding the ingredients to the vessel at programmed intervals to execute the recipe.

9. The portable ingredients system of claim 8, wherein the plurality of ingredients are used for making a soup, and the recipe comprises a soup recipe.

10. The portable ingredients system of claim 8, wherein the plurality of ingredients are used for making a pastry, and the recipe comprises a pastry recipe.

11. The portable ingredients system of claim 8, wherein the plurality of ingredients are used for brewing a beer, and the recipe comprises a beer recipe.

12. The portable ingredients system of claim 8, further comprising an outer wrap around the portable ingredients system, including the prepackaged ingredients and at least one recipe, to constitute a marketable kit for making a consumable food or drink.

13. An ingredient addition device, comprising:
a rotating mechanism having a plurality of vertically oriented tubes arranged in a circle equidistant from a center point and having a connection to a motor;
a base plate with an approximate diameter of an outer radius of the rotating mechanism and a hole for passing an ingredient contained in one of the vertically oriented tubes through the base plate;
the motor connected to the rotating assembly and the base plate such that activating the motor turns the rotating assembly relative to the base plate; and
a programmable controller to control the motor.

14. The ingredient addition device of claim 13, further comprising an attachment bracket to mount the ingredient addition device to a side of a kettle such that only a portion of the base plate containing the hole is over the kettle.

15. The ingredient addition device of claim 13, wherein the programmable controller is configured to:
connect to a network;
interface with a user via the network with respect to:
network configuration;
timing of ingredient addition;
operational testing;
statuses of time, ingredients, and position of the rotating mechanism;
execute a user-configured ingredient addition by:
tracking a time of day; and
at times specified by the user, driving the motor to line up a vertically oriented tube over the hole in the base plate allowing an ingredient in the vertically oriented tube to be added into the kettle via gravity.

16. The ingredient addition device of claim 13, wherein the motor drives the rotating mechanism via a reduction gear comprising gear teeth built into the rotating mechanism.

17. The ingredient addition device of claim 16, wherein the reduction gear comprises a single smaller pinion gear attached to the motor driving a larger internal planetary gear integral to the rotating assembly.

18. The ingredient addition device of claim 13, further comprising a movable seal between each vertically oriented tube and a stationary face of the base plate, wherein each movable seal secures an ingredient in a respective vertically oriented tube during rotation of the vertically oriented tube around the stationary face of the base plate until the vertically oriented tube aligns with the hole in the base plate.

19. The ingredient addition device of claim 13, further comprising a bearing ring on the base plate with an outer radius approximately equal to an inner radius tangential to each of the vertically oriented tubes, such that the bearing ring circularly aligns the rotating assembly as it rotates on the base plate.

20. The ingredient addition device of claim 13, wherein the motor comprises a stepper motor to turn the rotating mechanism a precise amount based on a given input from the programmable controller.
